(19) United States
(12) Patent Application Publication
(10) Pub. No.: US 2010/0097329 A1
(43) Pub. Date: Apr. 22, 2010

(54) Touch Position Finding Method and Apparatus

(76) Inventors: Martin Simmons, Southampton (GB); David Pickett, Southampton (GB)

Correspondence Address: SCHWEGMAN, LUNDBERG & WOESSNER / ATMEL, P.O. BOX 2938, MINNEAPOLIS, MN, 55402, US

(21) Appl. No.: 12/255,616

(22) Filed: Oct. 21, 2008

(51) Int. Cl. G06F 3/041

(52) U.S. Cl. 345/173

(57) ABSTRACT

In a touch sensor comprising a plurality of sensing nodes, the touch location in each dimension is obtained from the node at which the sum of the signal values assigned to the touch on either side of said node are equal or approximately equal. Each of the sensing nodes is replaced by a plurality of notional sensing nodes distributed around its respective sensing node over a distance corresponding to an internode spacing. Signal values 2, 6, 11, 5 and 2 have been obtained for the distribution of signal across the touch sensor. These signals are notionally split in equal spacings in the range covered by each node, each notional signal being shown with vertical tally sticks. The touch coordinate is then determined by finding the position of the median tally stick. Since there are 26 notional signals, each with a signal value of 1, the position of the median signal is between the 13th and 14th notional signals, as indicated by the thick arrow. This is a numerically simple method for obtaining touch coordinates at higher resolution than the resolution of the nodes ideally suited for implementation on a microcontroller.

### BACKGROUND OF THE INVENTION

The invention relates to a method and apparatus for computing the position of a touch on a touch sensor.

Two-dimensional (2D) touch screens, regardless of which technology is used, generally have a construction based on a matrix of sensor nodes that form a 2D array in Cartesian coordinates, i.e. a grid.

In a capacitive sensor, for example, each node is checked at each sampling interval to obtain the signal at that node, or in practice signal change from a predetermined background level. These signals are then compared against a predetermined threshold, and those above threshold are deemed to have been touched and are used as a basis for further numerical processing.

The simplest situation for such a touch screen is that a touch is detected by a signal that occurs solely at a single node on the matrix. This situation will occur when the size of the actuating element is small in relation to the distance between nodes. This might occur in practice when a stylus is used. Another example might be when a low resolution panel for finger sensing is provided, for example a 4×4 key matrix dimensioned 120 mm×120 mm.

Often the situation is not so simple, and a signal arising from a touch will generate significant signal at a plurality of nodes on the matrix, these nodes forming a contiguous group. This situation will occur when the size of the actuating element is large in relation to the distance between nodes. In practice, this is a typical scenario when a relatively high resolution touch screen is actuated by a human finger (or thumb), since the finger touch will extend over multiple nodes.

An important initial task of the data processing is to process these raw data to compute a location for each touch, i.e. the x, y coordinates of each touch. The touch location is of course needed by higher level data processing tasks, such as tracking motion of touches over time, which in turn might be used as input into a gesture recognition algorithm.

There are various known or straightforward solutions to this problem which are now briefly summarized

FIG. 3A shows a screen with a square sensitive area 10 defined by a matrix of 5 row electrodes and 3 column electrodes extending with a grid spacing of 20 mm to define 15 sensing nodes.

First, as alluded to above, the touch coordinate can simply be taken as being coincident with the node with the maximum signal. Referring to the figure, the maximum signal is 26 which is registered at node (2,2), and the touch location (x,y) is taken to be at that point.

A more sophisticated approach is to take account of signal values in the nodes immediately neighboring the node with the maximum signal when calculating the touch location. For the x coordinate an average could be computed taking account of the immediately left and right positioned nodes. Namely, one subtracts the lowest of these three values from the other two values and then performs a linear interpolation between the remaining two values to determine the x-position. Referring to the figure, we subtract 18 from 20 and 26 to obtain 2 and 8. The x-position is then computed to be ⅕ of the distance from 2 to 1, i.e. 1.8. A similar calculation is then made for the y-coordinate, i.e. we subtract 14 from 26 and 18 to obtain 12 and 4. The y-position is then 4/16 of the distance from 2 to 3, i.e. 2.25. The touch location is therefore (1.8, 2.25). As will be appreciated, this approach will also work with a touch consisting of only two nodes that are above the detection threshold, but of course the initial steps are omitted.

Another standard numerical approach would be to perform a centre of mass calculation on the signals from all nodes that “belong” to the touch concerned, as disclosed in US 2006/0097991[1]. These would be all nodes with signals above a threshold value and lying in a contiguous group around the maximum signal node. In the figure, these values are shaded.

The touch coordinate R can be calculated according to the centre of mass formula

$$R = \frac{{\sum }_{n = 1}^{N} {I}_{n} {r}_{n}}{{\sum }_{n = 1}^{N} {I}_{n}}$$

where Iₙ is the signal value of the nth node and rₙ is the location of the nth node. This equation can be separated out into x and y components to determine the X and Y coordinates of the touch from the coordinates xₙ and yₙ of the individual nodes.

$$X = \frac{{\sum }_{n = 1}^{N} {I}_{n} {x}_{n}}{{\sum }_{n = 1}^{N} {I}_{n}} \qquad Y = \frac{{\sum }_{n = 1}^{N} {I}_{n} {y}_{n}}{{\sum }_{n = 1}^{N} {I}_{n}}$$

In the example illustrated, this will yield

$$\begin{matrix}X = \frac{20 \times 1 + ( 14 + 26 + 18 ) \times 2 + ( 12 + 18 + 11 ) \times 3}{14 + 12 + 20 + 26 + 18 + 18 + 11} \\ = \frac{20 + 116 + 123}{119} \\ = \frac{259}{119} \\ = 2.18\end{matrix}$$

$$\begin{matrix}Y = \frac{( 14 + 12 ) \times 1 + ( 20 + 26 + 18 ) \times 2 + ( 18 + 11 ) \times 3}{14 + 12 + 20 + 26 + 18 + 18 + 11} \\ = \frac{26 + 128 + 87}{119} \\ = \frac{241}{119} \\ = 2.03\end{matrix}$$

The touch location is therefore calculated to be (2.18, 2.03).

A drawback of a centre of mass calculation approach is that it is relatively computationally expensive. As can be seen from the simple example above, there are a significant number of computations including floating point divisions. Using a microcontroller, it may take several milliseconds to compute the touch location of a frame, which is unacceptably slow.

A further drawback established by the inventors is that when a centroid calculation is applied, small changes in signal that are relatively distant from the origin chosen for the centre of mass calculation cause significant changes in the computed touch location. This effect becomes especially problematic for larger area touches where the maximum distance between nodes that are part of a single touch become large. If one considers that the touch location will be calculated for each sample, it is highly undesirable to have the computed touch location of a static touch moving from sample to sample in this way. This effect is further exacerbated in a capacitive touch sensor since the signal values are generally integer and small. For example, if a signal value at a node near the edge of a touch area changes between 11 to 12 from sample to sample, this alone may cause the computed touch location to move significantly causing jitter.

The above example has only considered a single touch on the screen. However, it will be appreciated that for an increasing number of applications it is necessary for the touch screen to be able to detect multiple simultaneous touches, so-called multitouch detection. For example, it is often required for the touch screen to be able to detect gestures, such as a pinching motion between thumb and forefinger. The above techniques can be extended to cater for multitouch detection.

U.S. Pat. No. 5,825,352[2] discloses a different approach to achieve the same end result. FIG. 1 illustrates this approach in a schematic fashion. In this example interpolation is used to create a curve in x, f(x), and another curve in y, f(y), with the respective curves mapping the variation in signal strength along each axis. Each detected peak is then defined to be a touch at that location. In the illustrated example, there are two peaks in x and one in y, resulting in an output of two touches at (x1, y1) and (x2, y2). As the example shows, this approach inherently caters for multitouch as well as single touch detection. The multiple touches are distinguished based on the detection of a minimum between two maxima in the x profile. This approach is well suited to high resolution screens, but requires considerable processing power and memory to implement, so is generally unsuited to microcontrollers.

It is noted that references above to ‘considerable processing power and memory’ reflect the fact that in many high volume commercial applications, e.g. for consumer products, where cost is an important factor, it is desirable to implement the touch detection processing in low complexity hardware, in particular microcontrollers. Therefore, although the kind of processing power being considered is extremely modest in the context of a microprocessor or digital signal processor, it is not insignificant for a microcontroller, or other low specification item, which has memory as well as numerical processing constraints.

### SUMMARY OF THE INVENTION

According to the invention there is provided a method of determining a touch location from a data set output from a touch screen comprising an array of sensing nodes, the data set comprising signal values for each of the sensing nodes, the method comprising:

a) receiving said data set as input;

b) identifying a touch in the data set, wherein a touch is defined by a subset of the data set made up of a contiguous group of nodes;

c) determining the touch location in each dimension as being at or adjacent the node at which the sum of the signal values assigned to the touch on either side of said node are equal or approximately equal.

The subset is modified by replacing at least the sensing node that is at or adjacent the touch location by a plurality of notional sensing nodes distributed around said sensing node. In some embodiments, the subset is modified by replacing each of the sensing nodes by a plurality of notional sensing nodes distributed around its respective sensing node. The notional sensing nodes are distributed over a distance or an area corresponding to an internode spacing. Distance refers to a one-dimensional spacing, which can be used in a one-dimensional touch sensor, e.g. a linear slider or scroll wheel, as well as in a two-dimensional touch sensor and in principle a three-dimensional touch sensor. Area refers to a two-dimensional distribution which can be used in a two-dimensional or higher dimensional touch sensor.

The signal values may be integers, and the plurality of notional sensing nodes equals the integer signal value at each sensing node, so that the signal value at each notional sensing node is unity. Alternatively, the method can be applied to sensors which output non-integer signal values.

The method may further comprise repeating steps b) and c) to determine the touch location of one or more further touches.

The touch location determined in step c) is combined with a further touch location determined by a method of interpolation between nodes in the touch data set. Step c) can be performed conditional on the touch data set having at least a threshold number of nodes, and if not the touch location is determined by a different method. For example, if there is only one node in the touch data set, the touch location is taken as the coordinates of that node. Another example, would be that the touch location is determined according to a method of interpolation between nodes in the touch data set when there are two nodes in the touch data set, or perhaps between 2 and said threshold number of nodes, which may be 3, 4, 5, 6, 7, 8, 9 or more for example.

Each dimension can consist of only one dimension. This may be the case for a one-dimensional touch sensor, including a closed loop as well as a bar or strip detector, and also a two-dimensional touch sensor being used only to detect position in one dimension. In other implementations, each dimension comprises first and second dimensions which would be typical for a two-dimensional sensor operating to resolve touch position in two dimensions.

It will be understood that the touch location computed according to the above methods will be output to higher level processes.

The invention also relates to a touch-sensitive position sensor comprising: a touch panel having a plurality of sensing nodes or elements distributed over its area to form an array of sensing nodes, each of which being configured to collect a location specific sense signal indicative of a touch; a measurement circuit connected to the sensing elements and operable repeatedly to acquire a set of signal values, each data set being made up of a signal value from each of the nodes; and a processor connected to receive the data sets and operable to process each data set according to the method of the invention. The array may be a one-dimensional array in the case of a one-dimensional sensor, but will typically be a two-dimensional array for a two-dimensional sensor. The processor is preferably a microcontroller.

Finally, it will be understood that reference to touch in this document follow usage in the art, and shall include proximity sensing. In capacitive sensing, for example, it is well known that signals are obtained without the need for physical touching of a finger or other actuator onto a sensing surface, and the present invention is applicable to sensors operating in this mode, i.e. proximity sensors.

### BRIEF DESCRIPTION OF THE DRAWINGS

For a better understanding of the invention, and to show how the same may be carried into effect, reference is now made by way of example to the accompanying drawings, in which:

FIG. 1 is schematically shows a prior art approach to identifying multiple touches on a touch panel;

FIG. 2 schematically shows in plan view a 2D touch-sensitive capacitive position sensor and associated hardware of an embodiment of the invention;

FIG. 3A illustrates an example output data set from the touch panel shown in FIG. 2;

FIG. 3B schematically illustrates the principle underlying the calculation of the coordinate location of a touch according to the invention;

FIG. 4 is a flow diagram showing a method for calculation of touch location at the highest level;

FIG. 5 is a flow diagram showing computation of the x coordinate using a first example method of the invention;

FIG. 6 is a flow diagram showing computation of the y coordinate using the first example method of the invention;

FIG. 7 shows a flow diagram showing computation of the x coordinate using a second example method of the invention;

FIG. 8 shows a flow diagram showing computation of the y coordinate using the second example method of the invention;

FIG. 9 shows a flow chart of a further touch processing method according to the invention; and

FIG. 10 schematically shows in plan view a 2D touch-sensitive capacitive position sensor and associated hardware of another embodiment of the invention.

### DETAILED DESCRIPTION

The methods of the invention are applied to sets of data output from a touch screen. A 2D touch screen will be used in the following detailed description. It is however noted that the methods are applicable to 1D touch sensors and also in principle to 3D sensor technology, although the latter are not well developed. The 2D touch screen is assumed to be made of a square grid of sensing nodes characterized by the same internode spacing in both orthogonal axes, which will be referred to as x and y in the following. It will however be understood that other node arrangements are possible, for example a rectangular grid could be used. Further, other regular grid patterns or arbitrary node distributions could be provided, which may be more or less practical depending on which type of touch screen is being considered, i.e. capacitive, resistive, acoustic etc. For example, a triangular grid could be provided.

When sampled, the touch screen is assumed to output a set of data comprising a scalar value for each sensing node, the scalar value being indicative of a quantity of signal at that node, and is referred to as a signal value. In the specific examples considered, this scalar value is a positive integer, which is typical for capacitive touch sensors.

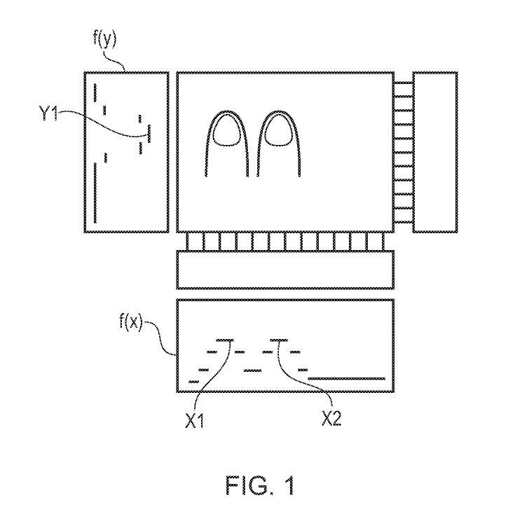

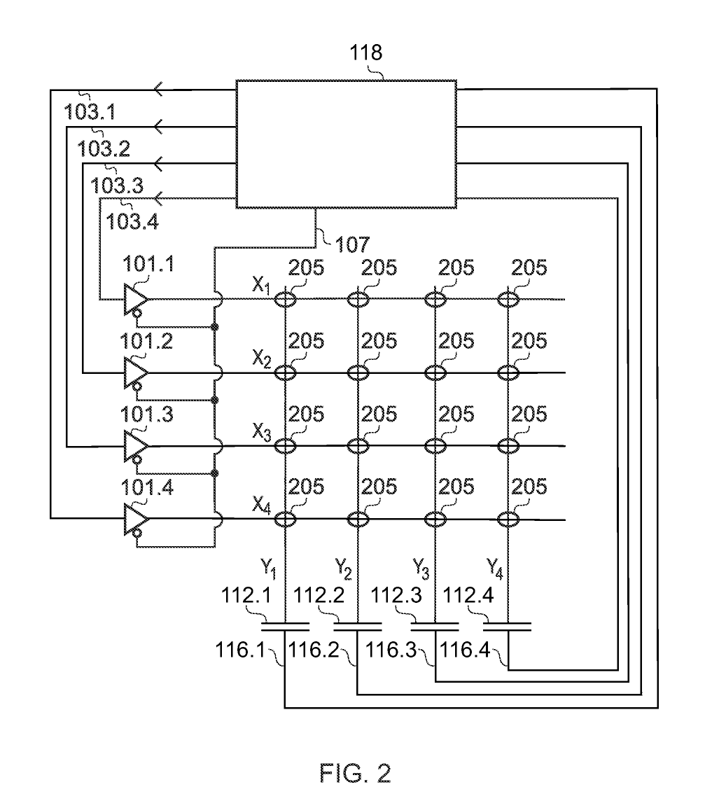

FIG. 2 is a circuit diagram illustrating a touch sensitive matrix providing a two-dimensional capacitive transducing sensor arrangement according to an embodiment of the invention. The touch panel shown in FIG. 1 comprises three column electrodes and five row electrodes, whereas that of FIG. 2 has a 4×4 array. It will be appreciated that the number of columns and rows may be chosen as desired, another example being twelve columns and eight rows or any other practical number of columns and rows.

The array of sensing nodes is accommodated in or under a substrate, such as a glass panel, by extending suitably shaped and dimensioned electrodes. The sensing electrodes define a sensing area within which the position of an object (e.g. a finger or stylus) to the sensor may be determined. For applications in which the sensor overlies a display, such as a liquid crystal display (LCD), the substrate may be of a transparent plastic material and the electrodes are formed from a transparent film of Indium Tin Oxide (ITO) deposited on the substrate using conventional techniques. Thus the sensing area of the sensor is transparent and can be placed over a display screen without obscuring what is displayed behind the sensing area. In other examples the position sensor may not be intended to be located over a display and may not be transparent; in these instances the ITO layer may be replaced with a more economical material such as a copper laminate Printed Circuit Board (PCB), for example.

There is considerable design freedom in respect of the pattern of the sensing electrodes on the substrate. All that is important is that they divide the sensing area into an array (grid) of sensing cells arranged into rows and columns. (It is noted that the terms “row” and “column” are used here to conveniently distinguish between two directions and should not be interpreted to imply either a vertical or a horizontal orientation.) Some example electrode patterns are disclosed in US 2008/0246496 A1 [6] for example, the contents of which are incorporated in their entirety.

It will be recognized by the skilled reader that the sensor illustrated in FIG. 2 is of the active or transverse electrode type, i.e. based on measuring the capacitive coupling between two electrodes (rather than between a single sensing electrode and a system ground). The principles underlying active capacitive sensing techniques are described in U.S. Pat. No. 6,452,514 [5]. In an active or transverse electrode type sensor, one electrode, the so called drive electrode, is supplied with an oscillating drive signal. The degree of capacitive coupling of the drive signal to the sense electrode is determined by measuring the amount of charge transferred to the sense electrode by the oscillating drive signal. The amount of charge transferred, i.e. the strength of the signal seen at the sense electrode, is a measure of the capacitive coupling between the electrodes. When there is no pointing object near to the electrodes, the measured signal on the sense electrode has a background or quiescent value. However, when a pointing object, e.g. a user's finger, approaches the electrodes (or more particularly approaches near to the region separating the electrodes), the pointing object acts as a virtual ground and sinks some of the drive signal (charge) from the drive electrode. This acts to reduce the strength of the component of the drive signal coupled to the sense electrode. Thus a decrease in measured signal on the sense electrode is taken to indicate the presence of a pointing object.

The illustrated m×n array is a 4×4 array comprising 4 drive lines, referred to as X lines in the following, and four sense lines, referred to as Y lines in the following. Where the X and Y lines cross-over in the illustration there is a sensing node 205. In reality the X and Y lines are on different layers of the touch panel separated by a dielectric, so that they are capacitively coupled, i.e. not in ohmic contact. At each node 205, a capacitance is formed between adjacent portions of the X and Y lines, this capacitance usually being referred to as C_{E} or Cₓ in the art, effectively being a coupling capacitor. The presence of an actuating body, such as a finger or stylus, has the effect of introducing shunting capacitances which are then grounded via the body by an equivalent grounding capacitor to ground or earth. Thus the presence of the body affects the amount of charge transferred from the coupling capacitor and therefore provides a way of detecting the presence of the body. This is because the capacitance between the X and Y “plates” of each sensing node reduces as the grounding capacitances caused by a touch increase. This is well known in the art.

In use, each of the X lines is driven in turn to acquire a full frame of data from the sensor array. To do this, a controller 118 actuates the drive circuits 101.1, 101.2, 101.3, 101.4 via control lines 103.1, 103.2, 103.3 and 103.4 to drive each of the X lines in turn. A further control line 107 to the drive circuits provides an output enable to float the output to the X plate of the relevant X line.

For each X line, charge is transferred to a respective charge measurement capacitor Cs 112.1, 112.2, 112.3, 112.4 connected to respective ones of the Y lines. The transfer of charge from the coupling capacitors 205 to the charge measurement capacitors Cs takes place under the action of switches that are controlled by the controller. For simplicity neither the switches or their control lines are illustrated. Further details can be found in U.S. Pat. No. 6,452,514 [5] and WO-00/44018 [7].

The charge held on the charge measurement capacitor Cs 112.1, 112.2, 112.3, 112.4 is measurable by the controller 118 via respective connection lines 116.1, 116.2, 116.3, 116.4 through an analog to digital converter (not shown) internal to the controller 118.

More details for the operation of such a matrix circuit are disclosed in U.S. Pat. No. 6,452,514 [5] and WO-00/44018 [7].

The controller operates as explained above to detect the presence of an object above one of the matrix of keys 205, from a change in the capacitance of the keys, through a change in an amount of charge induced on the key during a burst of measurement cycles.

The controller is operable to compute the number of simultaneous touches on the position sensor and to assign the discrete keys to one of the simultaneous touches using the algorithm described above. The discrete keys assigned to each of the touches are output from the controller to a higher level system component on an output connection. Alternatively, the host controller will interpolate each of the nodes assigned to each of the touches to obtain the coordinates of the touch.

The controller may be a single logic device such as a microcontroller. The microcontroller may preferably have a push-pull type CMOS pin structure. The necessary functions may be provided by a single general purpose programmable microprocessor, microcontroller or other integrated chip, for example a field programmable gate array (FPGA) or application specific integrated chip (ASIC).

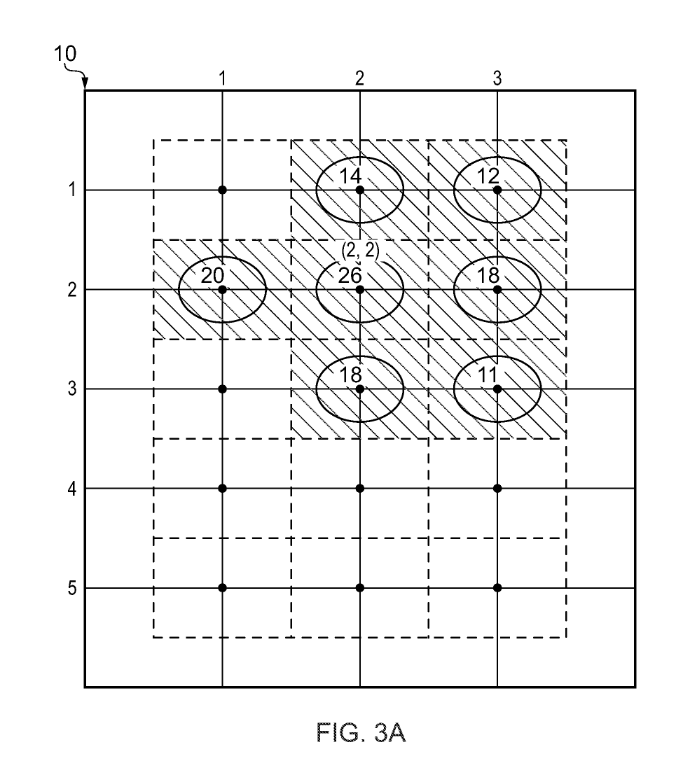

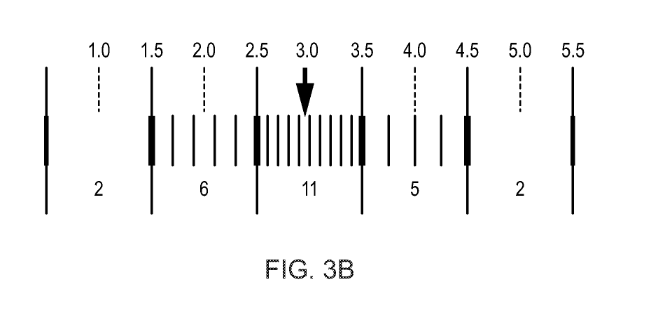

FIG. 3A illustrates an example output data set from a touch sensor array such as shown in FIG. 2, although the example of FIG. 3A is a 3×5 array, whereas FIG. 2 shows a 4×4 array.

As described above the output data set is preferably pre-processed to ascertain how many touches, if any, exist in the output data set. There may be no touches or one touch. In addition, if the device is configured to cater for the possibility, there may be multiple touches.

A touch is identified in the output data set by a contiguous group of nodes having signal values above a threshold. Each touch is therefore defined by a subset of the data set, this subset being referred to as a touch data set in the following. The group may have only one member, or any other integer number.

For example, in the output data set shown in FIG. 3A, there is one touch, the members of the group being shaded. Here the detect threshold is 10.

For higher level data processing, it is desirable for each touch to be given a specific touch location, i.e. an x, y coordinate.

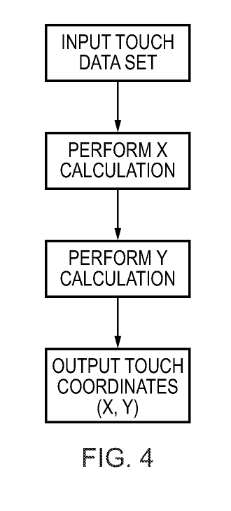

The methods of the invention relate to computation of the coordinates of the touch location of touch data set in particular in the case of touches made up of arbitrary numbers of nodes. As 2D touch screens are provided with higher and higher density grids as the technology develops, the number of nodes per touch is expected to rise. Currently, it is not uncommon for a touch to comprise 1-10 nodes, for example. FIG. 4 is a flow diagram showing a method for calculation of touch location at the highest level. This is generic to the first and second aspects described below. The method starts with input of a touch data set. The flow then progresses to respective steps of computing the x and y coordinates of the touch. Finally, these coordinates are output for use by higher level processing.

### Method 1

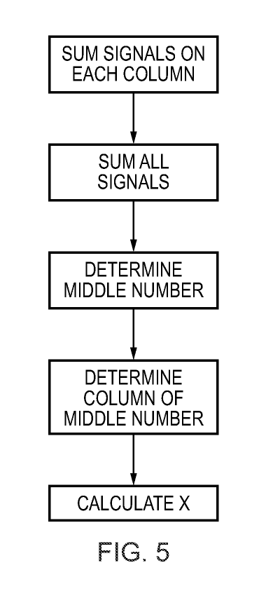

A first method for calculation of touch location is now described with reference to FIGS. 4, 5 and 6, and also FIG. 3A which provides a specific example. This method is the best mode.

Before describing Method 1 with reference to a specific example, we first discuss the principle underlying the calculation of the coordinate location of a touch according to the invention.

FIG. 3B schematically illustrates the principle. The principle may be considered to be analogous to calculation of an average using the median. By contrast, the prior art centre of mass approach may be considered analogous to calculating an average by the arithmetic mean.

According to the inventive principle, the touch location in each dimension is obtained from the node at which the sum of the signal values assigned to the touch on either side of said node are equal or approximately equal. To obtain finer resolution within this approach, each of the sensing nodes is replaced by a plurality of notional sensing nodes distributed around its respective sensing node over a distance corresponding to an internode spacing. This principle is illustrated with an example set of numbers in FIG. 3B which is confined to a single dimension, which we assume to be the x coordinate. Signal values 2, 6, 11, 5 and 2 (bottom row of numbers in figure) have been obtained for the distribution of signal across the touch screen obtained from columns 1 to 5 positioned at x coordinates 1 to 5 respectively (top row of numbers in the figure). Taking the x=1 column first, this has a signal value of 2, and this signal is notionally split into two signal values of 1 positioned in equal spacings in the x-range 0.5 to 1.5, the internode spacing being 1. The 2 notional signals are shown with vertical tally sticks. The x=2 column has a signal value of 6, and this is split into 6 notional signals of 1 distributed from x=1.5 to 2.5. The thicker tally sticks diagrammatically indicate that there are two sticks at the same x-coordinate from adjacent nodes.

The x-touch coordinate is then determined by finding the position of the median tally stick. Since there are 26 notional signals (each with a signal value of 1), i.e. the sum of all signal values is 26, the position of the median signal is between the 13th and 14th tally sticks or notional signals. This is the position indicated by the thick arrow, and is referred to as the median position in the following. In this example, there is an even number of notional signals. However, if there were an odd number of notional signals, the median would be coincident with a unique one of the notional signals. To avoid calculating the mean between two positions in the case of even numbers an arbitrary one of the two, e.g. the leftmost, can be taken.

This is a numerically very simple method for obtaining an x-coordinate at far higher resolution than the resolution of the column electrodes without resorting to more involved algebra, such as would be necessary with a centre of mass calculation.

The same approach can of course be used for the y-coordinate, or any other coordinate.

The same approach can also be generalized to two-dimensions, wherein the signals are notionally distributed over an area, rather than along one dimension. For example, if the signal value is, say 64, the signal could be notionally split into 64 single value signals spread over a two-dimensional 8×8 grid covering the area assigned to the xy electrode intersection that defines the nodes.

Bearing this principle in mind, Method 1 is now described. It should be noted in advance that the principle described with reference to FIG. 3B also applies to Method 2 and the other embodiments.

A final general observation is that it will be appreciated that the notional replacement of each raw signal with multiple signals need only be carried out for the signal value that is closest to the touch location, since it is only here that the additional resolution is needed. Referring to the FIG. 3B example, therefore only the signal value 11 needs to be divided up between 2.5 and 3.5, and the same result can be achieved. This may be viewed as an alternative approach lying within the scope of the invention. In other words, it is only necessary to replace the sensing node that is closest to the touch location by multiple notional sensing nodes distributed around the sensing node.

FIG. 4 is a flow diagram showing computation of the x coordinate. The steps shown in the flow diagram in FIG. 4 are now used in conjunction with the output data set shown in FIG. 3A.

The signals in each of the columns are summed. Using the output data set from FIG. 3A, the three columns are summed to 20, 58 and 41 respectively, going from left to right.

Each of the column sums are summed together. Using the output data set from FIG. 3A the summed columns from above are summed, i.e. 20+58+41=119.

The median position of the sum of all signals is found. Using the output data set from FIG. 3A the median position is 60.

The column containing the median position is identified by counting up from 1 starting at the far left of the output data set. Using the output data set from FIG. 3A, the output data set is counted as follows:
Column 1 counts from 1 to 20
Column 2 counts from 21 to 78
Column 3 counts from 79 to 119

Therefore the median position of 60 is in Column 2. This is interpreted as the x coordinate lies in the second column, or at a coordinate between 1.5 and 2.5.

To calculate where the x coordinate lies between 1.5 and 2.5, the median position and the summed column value of the median column are used. The summed column signals to the left of the median column are summed and subtracted from the median position. This is calculated using the data set shown in FIG. 3A and the median position calculated above to be 60−20=40. This result is then divided by the summed signal value of the median column calculated above i.e. 40/58=0.69. The result of this is then summed with 1.5, which is the x coordinate at the left edge of the median column. Therefore, the x coordinate is calculated to be 2.19.

In the above method for calculating the x coordinate the median of the total summed signal values is used. However, if the median lies between two of the columns, at 1.5 for example, then the mean could be used or either column could be arbitrarily chosen.

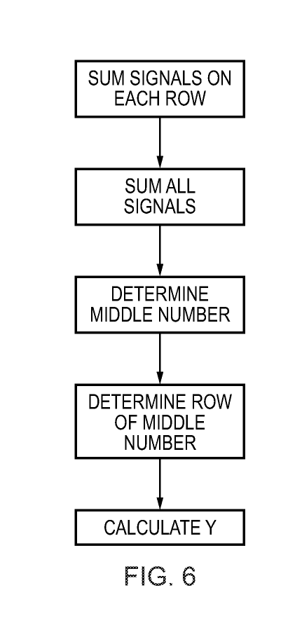

FIG. 6 is a flow diagram showing computation of the y coordinate. The steps shown in the flow diagram in FIG. 6 are now used in conjunction with the output data set shown in FIG. 3A.

The signals in each of the rows are summed. Using the output data set from FIG. 3A, the three rows are summed to 26, 64 and 29 respectively, going from top to bottom.

Each of the row sums are summed together. Using the output data set from FIG. 3A the summed rows from above are summed, i.e. 26+64+29=119. It is noted that the result from this step is the same as the result obtained when summing the column sums.

The median of the sum of all signals is found. Using the output data set from FIG. 3A the median position is 60. It is noted that the result from this step is the same as the result obtained when finding the median of the summed column sums.

The row containing the median position is identified by counting up from 1 starting at the top of the output data set. Using the output data set from FIG. 3A, the output data set is counted as follows:
Row 1 counts from 1 to 26
Row 2 counts from 27 to 90
Row 3 counts from 91 to 119

Therefore the median position of 60 is in Row 2. This is interpreted as the y coordinate lies in the second row, or at a coordinate between 1.5 and 2.5.

To calculate where the y coordinate lies between 1.5 and 2.5, the median position and the summed row value of the median row are used. The summed row signals above the median row are summed and subtracted from the median position. This is calculated using the data set shown in FIG. 3A and the median position calculated above to 60=26=34. This result is then divided by the summed signal value of the median row, calculated above i.e. 34/64=0.53. The result of this is then summed with 1.5, which is the y coordinate at the upper edge of the median row. Therefore, the y coordinate is calculated to be 2.03.

The coordinate of a touch adjacent the touch panel shown in FIG. 3A, with signal values shown on FIG. 3A has been calculated to be (2.19, 2.03).

### Method 2

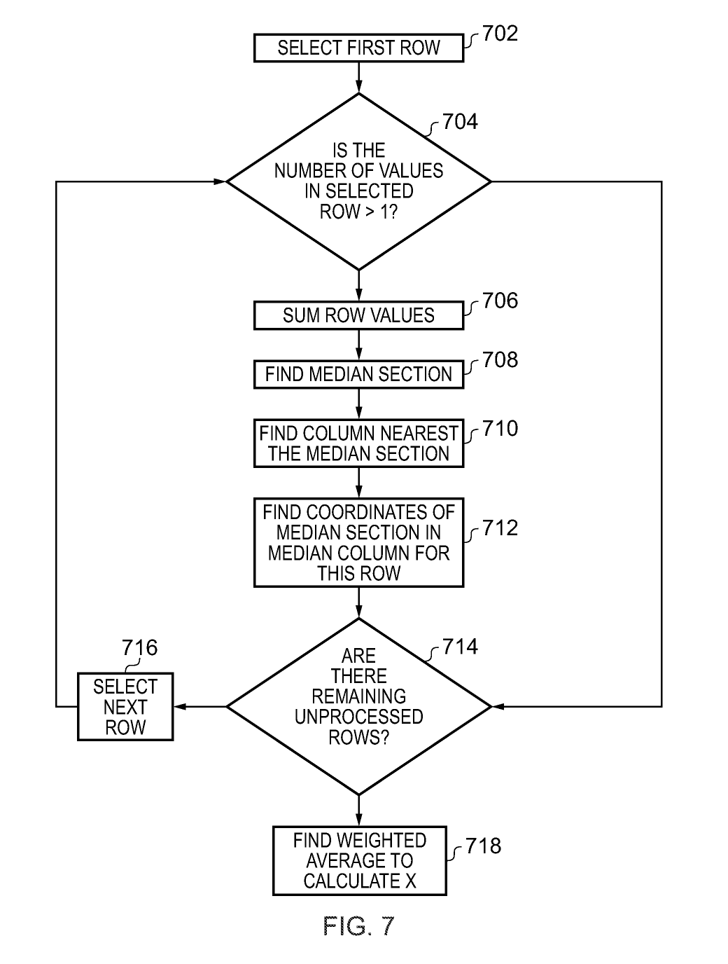

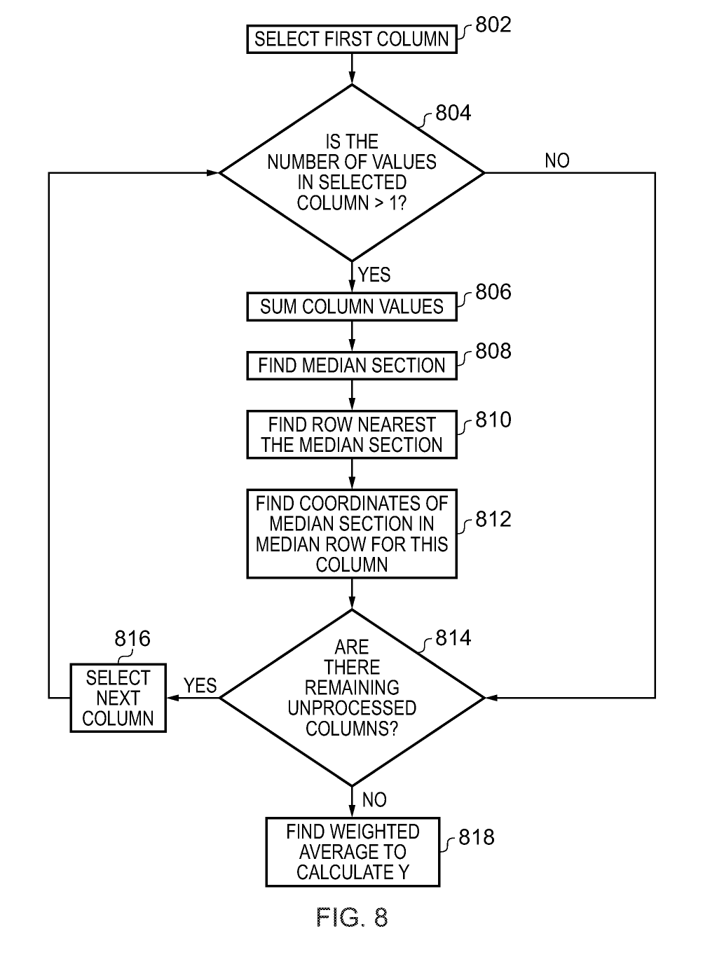

A second method for the calculation of touch location is now described with reference to FIGS. 7 and 8, and also FIG. 3A which provides a specific example.

FIG. 7 is a flow diagram showing computation of the x coordinate. The steps shown in the flow diagram in FIG. 7 are now used in conjunction with the output data set shown in FIG. 3A.

In step 702, the first row is selected. Using the data set show in FIG. 3A, the upper most row is selected. However, it will be appreciated that any row can be selected. For ease of understanding the foregoing, the first selected row will be referred to as X₁, the second selected row will be referred to as X₂ and the third selected row will be referred to as X₃.

In step 704, the selected row is checked to identify how many signal values are contained in the data set for the selected row X₁. If only one row signal is present then the process goes to step 714. This is interpreted to mean that it is not necessary to carry out steps 706 to 712 on the selected row.

In step 706 the signals in the selected row X₁ are summed. Using the output data set from FIG. 3A, the selected row is summed to 26. As will be shown below, the process is repeated for each of the rows. Therefore the second row X₂ and third row X₃ of the data set shown in FIG. 3A are summed to 64 and 29 respectively.

In step 708 the median of the summed selected row X₁ is calculated. Using the output data set from FIG. 3A the median position of the selected row X₁ is calculated to be 13.5 As will be shown below, the process is repeated for each of the rows. Therefore the median of the second row X₂ and the third row X₃ of the data set shown in FIG. 3A are 32.5 and 15 respectively.

In step 710 the column containing the median position for the selected row X₁ is identified by counting up from 1 starting at the far left of the output data set. Using the output data set from FIG. 3A, the output data set is counted as follows:
Column 1 counts from -
Column 2 counts from 1 to 14
Column 3 counts from 15 to 26

There is no count in Column 1 for the selected row X₁, since there is no signal detected in Column 1 of the output data set for the selected row X₁.

Therefore the median position for the selected row X₁ is in Column 2.

As will be shown below, the process is repeated for each of the rows. Therefore the column containing the median position for the second row X₂ and third row X₃ are also identified. Using the output data set from FIG. 3A for the second row X₂ the output data set is counted as follows:
Column 1 counts from 1 to 20
Column 2 counts from 21 to 46
Column 3 counts from 47 to 64

Using the output data set from FIG. 3A for the third row X₃ the output data set is counted as follows:
Column 1 counts from -
Column 2 counts from 1 to 18
Column 3 counts from 19 to 29

Therefore the median position for the second row X₂ and the third row X₃ is also in Column 2. This is interpreted to mean that the x coordinate lies in the second column, or at a coordinate between 1.5 and 2.5 for each of the rows X₁, X₂ and X₃.

In step 712, the x coordinate for the selected row X₁ is calculated using the median position for the row X₁ and the signal value of the selected row in the median column. The signals to the left of the median column in the selected row are summed and subtracted from the median position i.e. 13.5−0=13.5. This result is then divided by the signal of the median column in the selected row X₁. Using the data set shown in FIG. 3A, this is calculated to be 13.5/14=0.96. The result of this is then summed with 1.5, which is the x coordinate at the left edge of the median column. Therefore, the x coordinate of the selected row X₁ is calculated to be 2.46.

As will be shown below, the process is repeated for each of the rows. Therefore the coordinates for the second row X₂ (1.5+12.5/26=1.98) and the third row X₃ (1.5+15/18 2.33) are calculated to be 1.98 and 2.33 respectively.

In step 714, if there are remaining unprocessed rows, the process goes to step 716, where the next row is selected and the process in steps 704-714 is repeated. For ease of the explanation this has already been shown for each of the three rows of the data set shown in FIG. 1.

In step 718, each of the x coordinate for each of the rows are used to calculate the actual x coordinate using a weighted average, as shown below:

$$X = \frac{{\sum }_{n = 1}^{N} {I}_{n} {x}_{n}}{{\sum }_{n = 1}^{N} {I}_{n}}$$

Using the x coordinates for the rows X₁ (2.46), X₂ (1.98) and X₃ (2.33) and the signal values from the data set shown in FIG. 3A, the x coordinate is calculated as follows:

$$\begin{matrix}X = \frac{( 2.46 \times 26 ) + ( 1.98 \times 64 ) + ( 2.33 \times 29 )}{26 + 64 + 29} \\ = \frac{64.0 + 126.7 + 67.6}{119} \\ = \frac{258}{119} \\ = 2.16\end{matrix}$$

Therefore the x coordinate is calculated to be 2.16.

FIG. 8 is a flow diagram showing computation of the y coordinate. The steps shown in the flow diagram in FIG. 8 are now used in conjunction with the output data set shown in FIG. 3A.

In step 802, the first column is selected. Using the data set shown in FIG. 3A, the left most column is selected. However, it will be appreciated that any column can be selected. For ease of understanding the foregoing, the first selected column will be referred to as Y₁, the second selected column will be referred to as Y₂ and the third selected column will be referred to as Y₃.

In step 804, the selected column is checked to identify how many signal values are contained in the data set for the selected column Y₁. If only one column signal is present then the process goes to step 814. This is interpreted to mean that it is not necessary to carry out steps 806 to 812 on the selected row. Using the output data set from FIG. 3A, there is only one signal value in the selected column Y₁. Therefore, the process will go to step 814. The signal value for the selected column Y₁ will be used in the weighted average calculation at the end of the process in step 814. For the weighted average calculation of the coordinate for column Y₁ will be taken as 2, since it lies on the electrode at coordinate 2 in the output data set shown n FIG. 3A.

In step 814, if there are remaining unprocessed columns, the process goes to step 816, where the next column is selected and the process in steps 804-814 is repeated. Since the first selected column Y₁ only contains one signal value, the next column will be selected (column Y₂) and the process in steps 804 to 814 will be applied to illustrate how the process is used to calculate the coordinate of one of the columns. Therefore the following process steps will be applied to column Y_{2.}, since it contains more than one signal value.

In step 806 the signals in the selected column Y₂ are summed. Using the output data set from FIG. 3A, the selected column is summed to 58. As will be shown below, the process is repeated for the third column Y₃. Therefore the third column Y₃ of the data set shown in FIG. 3A is summed to 41.

In step 808 the median of the summed selected column Y₂ is calculated. Using the output data set from FIG. 3A the median position of the selected column Y₂ is calculated to be 29.5. As will be shown below, the process is repeated for column Y₃. Therefore the median of the third column Y₃ of the data set shown in FIG. 3A is 21.

In step 810 the rows containing the median position for the selected column Y₂ is identified by counting up from 1 starting at the upper most of the output data set. Using the output data set from FIG. 3A, the output data set is counted as follows:
Row 1 counts from 1 to 14
Row 2 counts from 15 to 40
Row 3 counts from 41 to 58

Therefore the median position for the selected row Y₂ is in row 2.

As will be shown below, the process is repeated for column Y₃. Therefore the row containing the median position for the third column Y₃ is also identified. Using the output data set from FIG. 3A for the third column Y₃ the output data set is counted as follows:
Row 1 counts from 1-12
Row 2 counts from 13 to 30
Row 3 counts from 31 to 41

Therefore the median position for the third column Y₃ is also in row 2. This is interpreted to mean that the y coordinate lies in the second row, or at a coordinate between 1.5 and 2.5 for each of the columns Y₂ and Y₃.

In step 812, the Y coordinate for the selected column Y₂ is calculated using the median position for the column Y₂ and the signal value of the selected column in the median row. The signals above the median row in the selected column are summed and subtracted from the median medium i.e. 29.5−14=15.5. This result is then divided by the signal of the median row in the selected column Y₂. Using the data set shown in FIG. 3A, this is calculated to be 15.5/26=0.6. The result of this is then summed with 1.5, which is the y coordinate at the upper edge of the median row. Therefore, the y coordinate of the selected row Y₂ is calculated to be 2.1.

As will be shown below, the process is repeated for each column Y₃. Therefore the coordinates for the third column Y₃ (1.5+9/18=2) is calculated to be 2.

In step 814, if there are remaining unprocessed rows, the process goes to step 816, where the next column is selected and the process in steps 804-814 are repeated. For ease of the explanation this has already been shown for each of the three columns of the data set shown in FIG. 3A.

In step 818, each of the y coordinate for each of the columns are used to calculate the actual Y coordinate using a weighted average, as shown below:

$$Y = \frac{{\sum }_{n = 1}^{N} {I}_{n} {y}_{n}}{{\sum }_{n = 1}^{N} {I}_{n}}$$

Using the Y coordinates for the rows Y₁ (2), Y₂ (2.1) and Y₃ (2) and the signal values from the data set shown in FIG. 3A, the y coordinate is calculated as follows:

$$\begin{matrix}Y = \frac{( 2 \times 20 ) + ( 2.1 \times 58 ) + ( 2 \times 41 )}{20 + 58 + 41} \\ = \frac{40 + 121.8 + 82}{119} \\ = \frac{253.8}{119} \\ = 2.05\end{matrix}$$

Therefore the y coordinate is calculated to be 2.05.

The coordinate of the a touch adjacent the touch panel shown in FIG. 3A, with signal values shown on FIG. 3A has been calculated to be (2.16, 2.05).

It will be appreciated that in Method 2, or Method 1, the signal values can be modified prior to application of either method. For example, the threshold could be subtracted from the signal values, or a number equal to or slightly less than, e.g. 1 less than, the signal value of the lowest above-threshold signal. In the above examples the threshold is 10, so this value could be subtracted prior to applying the process flows described above.

### Variant Method

Having now described two methods of determining the touch location, namely Method 1 and Method 2, it will be appreciated that these methods are ideally suited to handling touch data sets made up of several nodes. On the other hand, these methods are somewhat over complex if the touch data set only contains a single node, or perhaps also only 2 or 3 nodes.

In the variant method now described, touch location is calculated by applying a higher level process flow which selects one of a plurality of calculation methods depending on the number of nodes in the touch data set.

Either of Method 1 or Method 2 can form part of the variant method, but we take it to be Method 1 in the following.

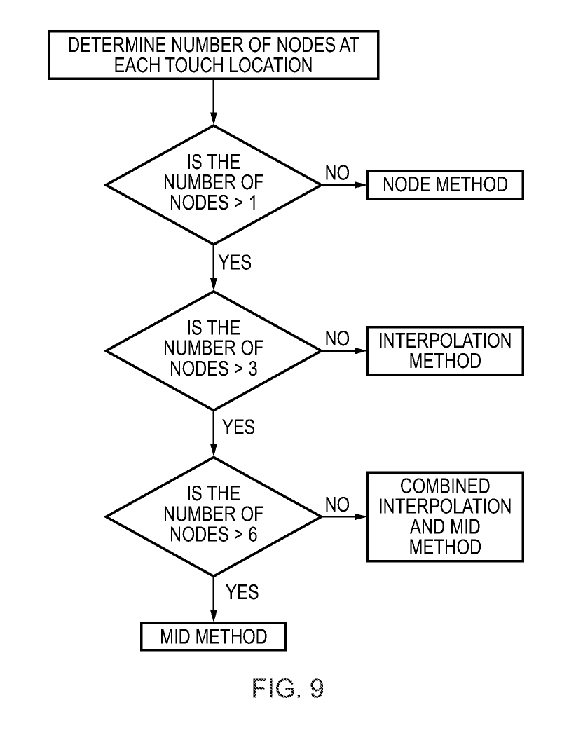

FIG. 9 shows a flow chart that is used to determine which coordinate calculation method is used. It will be appreciated that there might be multiple touches in the data set output from a touch panel. If there are multiple touches present in the data set then each touch location is calculated individually. The following steps are used to determine which method to apply for calculation of the location of the touch.

The number of nodes in the data set for each touch is determined. This will be used to identify the most appropriate coordinate calculation method.

If there is only 1 node in a touch data set, the coordinates of that node are taken to be the coordinates of the touch location.

If there are 2 or 3 nodes, then an interpolation method is used. To illustrate how the interpolation method is used a touch comprising three nodes will be used. The nodes are at coordinates (1, 2), (2, 2) and (2, 3) with signal values of 20, 26 and 18 respectively. To calculate the x coordinate the nodes at coordinate (1, 2) and (2, 2) are used, i.e. the two nodes in the x-direction. To calculate the x coordinate the signal value at coordinate (1, 2) which is the left most coordinate, is divided by the sum of the two signal values i.e. 20/(20+26)=0.43. The result is then added to 1, since the touch is located between coordinates 1 and 2. Therefore, the x coordinate is 1.43.

A similar method is applied to the signal values in the y direction, namely coordinates (2, 3) and (2, 2) with signal values 26 and 18 respectively. To calculate the y coordinate the signal value at coordinate (2, 2) which is the upper most coordinate, is divided by the sum of the two signal values 26/(26+18)=0.59. The result is then added to 2, since the touch is located between coordinates 2 and 3. Therefore, the y coordinate is 2.59. Thus, the coordinates of the touch are (1.43, 2.59), calculated using the interpolation method.

If there are 4, 5 or 6 nodes in the touch data set, a hybrid method is used. The hybrid method calculates the coordinates according to both Method 1 and the above-described interpolation method, and the results of the two methods are averaged using a weighted average, where the weighting varies according to the number of nodes to gradually move from a situation in which the interpolation contribution has the highest weighting for the lower numbers of nodes to a situation in which the median method contribution has the highest weighting for the higher number of nodes. This ensures a smooth transition in the touch coordinates when the number of nodes varies between samples, thereby avoiding jitter.

In other words, when the interpolation method is used for more than three nodes the in-detect key with the highest value and it adjacent neighbors are used in the interpolation calculation. Once the two sets of coordinates are calculated the touch location is then taken as an average, preferably a weighted average, or the touch locations obtained by these two methods. For example, if there are 4 nodes the weighting used could be 75% of the interpolation method coordinates and 25% of the Method 1 coordinates.

### ALTERNATIVE EMBODIMENT

It will be appreciated that the touch sensor forming the basis for the above described embodiment is an example of a so-called active or transverse type capacitive sensor. However, the invention is also applicable to so-called passive capacitive sensor arrays. Passive or single ended capacitive sensing devices rely on measuring the capacitance of a sensing electrode to a system reference potential (earth). The principles underlying this technique are described in U.S. Pat. No. 5,730,165 and U.S. Pat. No. 6,466,036, for example in the context of discrete (single node) measurements.

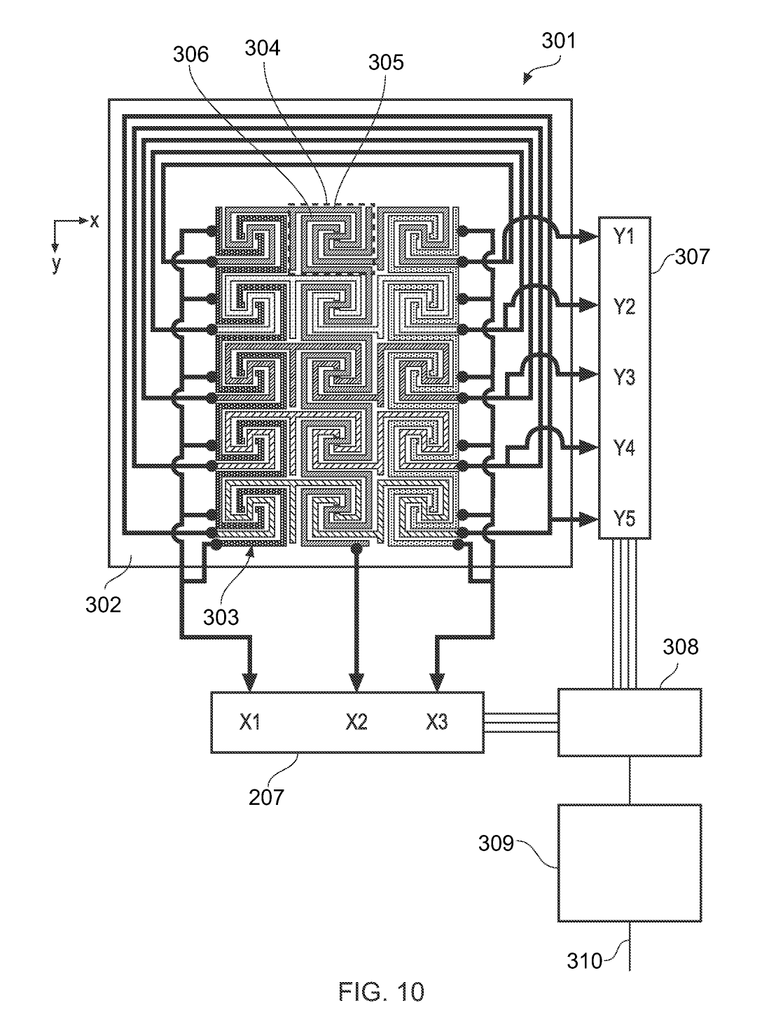

FIG. 10 schematically shows in plan view a 2D touch-sensitive capacitive position sensor 301 and accompanying circuitry according to an passive-type sensor embodiment of the invention.

The 2D touch-sensitive capacitive position sensor 301 is operable to determine the position of objects along a first (x) and a second (y) direction, the orientation of which are shown towards the top left of the drawing. The sensor 301 comprises a substrate 302 having sensing electrodes 303 arranged thereon. The sensing electrodes 303 define a sensing area within which the position of an object (e.g. a finger or stylus) to the sensor may be determined. The substrate 302 is of a transparent plastic material and the electrodes are formed from a transparent film of Indium Tin Oxide (ITO) deposited on the substrate 302 using conventional techniques. Thus the sensing area of the sensor is transparent and can be placed over a display screen without obscuring what is displayed behind the sensing area. In other examples the position sensor may not be intended to be located over a display and may not be transparent; in these instances the ITO layer may be replaced with a more economical material such as a copper laminate Printed Circuit Board (PCB), for example.

The pattern of the sensing electrodes on the substrate 302 is such as to divide the sensing area into an array (grid) of sensing cells 304 arranged into rows and columns. (It is noted that the terms “row” and “column” are used here to conveniently distinguish between two directions and should not be interpreted to imply either a vertical or a horizontal orientation.) In this position sensor there are three columns of sensing cells aligned with the x-direction and five rows of sensing cells aligned with the y-direction (fifteen sensing cells in total). The top-most row of sensing cells is referred to as row Y1, the next one down as row Y2, and so on down to row Y5. The columns of sensing cells are similarly referred to from left to right as columns X1 to X3.

Each sensing cell includes a row sensing electrode 305 and a column sensing electrode 306. The row sensing electrodes 305 and column sensing electrodes 306 are arranged within each sensing cell 304 to interleave with one another (in this case by squared spiraling around one another), but are not galvanically connected. Because the row and the column sensing electrodes are interleaved (intertwined), an object adjacent to a given sensing cell can provide a significant capacitive coupling to both sensing electrodes irrespective of where in the sensing cell the object is positioned. The characteristic scale of interleaving may be on the order of, or smaller than, the capacitive footprint of the finger, stylus or other actuating object in order to provide the best results. The size and shape of the sensing cell 304 can be comparable to that of the object to be detected or larger (within practical limits).

The row sensing electrodes 305 of all sensing cells in the same row are electrically connected together to form five separate rows of row sensing electrodes. Similarly, the column sensing electrodes 306 of all sensing cells in the same column are electrically connected together to form three separate columns of column sensing electrodes.

The position sensor 301 further comprises a series of capacitance measurement channels 307 coupled to respective ones of the rows of row sensing electrodes and the columns of column sensing electrodes. Each measurement channel is operable to generate a signal indicative of a value of capacitance between the associated column or row of sensing electrodes and a system ground. The capacitance measurement channels 307 are shown in FIG. 10 as two separate banks with one bank coupled to the rows of row sensing electrodes (measurement channels labeled Y1 to Y5) and one bank coupled to the columns of column sensing electrodes (measurement channels labeled X1 to X3). However, it will be appreciated that in practice all of the measurement channel circuitry will most likely be provided in a single unit such as a programmable or application specific integrated circuit. Furthermore, although eight separate measurement channels are shown in FIG. 10, the capacitance measurement channels could alternatively be provided by a single capacitance measurement channel with appropriate multiplexing, although this is not a preferred mode of operation. Moreover, circuitry of the kind described in U.S. Pat. No. 5,463,388 [2] or similar can be used, which drives all the rows and columns with a single oscillator simultaneously in order to propagate a laminar set of sensing fields through the overlying substrate.

The signals indicative of the capacitance values measured by the measurement channels 307 are provided to a processor 308 comprising processing circuitry. The position sensor will be treated as a series of discrete keys or nodes. The position of each discrete key or nodes is the intersection of the x- and y-conducting lines. The processing circuitry is configured to determine which of the discrete keys or nodes has a signal indicative of capacitance associated with it. A host controller 309 is connected to receive the signals output from the processor 308, i.e. signals from each of the discrete keys or nodes indicative of an applied capacitive load. The processed data can then be output by the controller 309 to other systems components on output line 310.

The host controller is operable to compute the number of touches that are adjacent the touch panel and associate the discrete keys in detect to each touch that is identified. Simultaneous touches adjacent the position sensor could be identified using one of method discloses in the prior art documents U.S. Pat. No. 6,888,536[1], U.S. Pat. No. 5,825,352[2] or US 2006/0097991 A1 [4] for example or any other known method for computing multiple touches on a touch panel. Once the host controller has identified the touches and the discrete keys associated with each of these touches, the host controller is operable to compute the coordinates of the touch or simultaneous touches using the methods described above for the other embodiment of the invention. The host controller is operable to output the coordinates on the output connection.

The host controller may be a single logic device such as a microcontroller. The microcontroller may preferably have a push-pull type CMOS pin structure, and an input which can be made to act as a voltage comparator. Most common microcontroller I/O ports are capable of this, as they have a relatively fixed input threshold voltage as well as nearly ideal MOSFET switches. The necessary functions may be provided by a single general purpose programmable microprocessor, microcontroller or other integrated chip, for example a field programmable gate array (FPGA) or application specific integrated chip (ASIC).

### REFERENCES

[1] U.S. Pat. No. 6,888,536
[2] U.S. Pat. No. 5,825,352
[3] U.S. Pat. No. 5,463,388
[4] US 2006/0097991 A1
[5] U.S. Pat. No. 6,452,514
[6] US 2008/0246496 A1
[7] WO-00/44018

What is claimed is:

1. A method of determining a touch location from a data set output from a touch screen comprising an array of sensing nodes, the data set comprising signal values for each of the sensing nodes, the method comprising:
a) receiving said data set as input;
b) identifying a touch in the data set, wherein a touch is defined by a subset of the data set made up of a contiguous group of nodes;
c) determining the touch location in each dimension as being at or adjacent the node at which the sum of the signal values assigned to the touch on either side of said node are equal or approximately equal.

2. The method of claim 1, wherein said subset is modified by replacing at least the sensing node that is at or adjacent the touch location by a plurality of notional sensing nodes distributed around said sensing node.

3. The method of claim 1, wherein said subset is modified by replacing each of the sensing nodes by a plurality of notional sensing nodes distributed around its respective sensing node.

4. The method of claim 2, wherein the notional sensing nodes are distributed over a distance or an area corresponding to an internode spacing.

5. The method of claim 2, wherein the signal values are integers, and the plurality of notional sensing nodes equals the integer signal value at each sensing node, so that the signal value at each notional sensing node is unity.

6. The method of claim 1, further comprising repeating steps b) and c) to determine the touch location of one or more further touches.

7. The method of claim 1, wherein the touch location determined in step c) is combined with a further touch location determined by a method of interpolation between nodes in the touch data set.

8. The method of claim 1, wherein step c) is performed conditional on the touch data set having at least a threshold number of nodes, and if not the touch location is determined by a different method.

9. The method of claim 1, wherein each dimension consists of only one dimension.

10. The method of claim 1, wherein each dimension comprises first and second dimensions.

11. The method of claim 1, further comprising:
outputting the touch location.

12. A touch-sensitive position sensor comprising:
a touch panel having a plurality of sensing elements distributed over its area to form an array of sensing nodes, each of which being configured to collect a location specific sense signal indicative of a touch;
a measurement circuit connected to the sensing elements and operable repeatedly to acquire a set of signal values, each data set being made up of a signal value from each of the nodes; and
a processor connected to receive the data sets and operable to process each data set according to the method of claim 1.
